(19) United States
(12) Patent Application Publication
(10) Pub. No.: US 2009/0240606 A1
(43) Pub. Date: Sep. 24, 2009

(54) Internal Process Audit Surveillance System

(75) Inventors: Linda C. Oakman, Windsor Mill, MD (US); Ricardo L. Rivera, Eldersburg, MD (US); Christian E. Roehl, East Wakefield, NH (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International, Inc, Morristown, NJ (US)

(21) Appl. No.: 12/053,813

(22) Filed: Mar. 24, 2008

(51) Int. Cl. G06Q 10/00

(52) U.S. Cl. 705/30

(57) ABSTRACT

A system and methods for auditing one or more auditable items are provided. The auditable items are associated with one or more audit checklists. The audit checklists comprise one or more audit-header questions and one or more audit-checklist questions. The auditable items are associated with the audit checklists. The auditable items may be associated with the audit checklists based on answers to the audit-header questions. The audit checklists are completed for the auditable items. The audit checklists may be completed by answering the audit-checklist questions. To audit the auditable items, one or more audit reports are generated. The audit reports are based at least in part on the completed audit checklists.

### BACKGROUND OF THE INVENTION

This invention relates to the field of auditing. Most particularly, this invention relates to a method and system for auditing by use of computer software configured to present one or more audit checklists to be answered for each auditable item subject to an audit.

An organization, such as a corporation, government, or non-profit entity, frequently has to ensure compliance with a set of regulations. A set of regulations typically includes public laws, financial and other regulations, quality standards, and/or internal controls of the organization. One method to ensure compliance with the set of regulations is to perform an audit of the organization's records. To perform an audit, an auditor examines the records of the organization, compares the records to standards required by the set of regulations, and issues an audit report. The audit report describes the relevance, accuracy, validity, quality, and/or completeness of the records with respect to the set of regulations. Typically, auditors are classified as either internal auditors, who are employed by or otherwise part of the organization, or external auditors, who are not part of the organization.

Audits are required for organizations for a variety of reasons. Organizations having contracts with the United States Government or other governments are required to show compliance with a set of regulations and laws to receive payment, retain business, and show the organization is meeting its contractual obligations. One such set of regulations for organizations contracting with the United States Government is the Federal Acquisition Regulations (FAR). Publicly-held corporations (i.e., corporations whose stock trades on an open market in the United States) are required to audit and then disclose financial information according to rules promulgated by the Securities and Exchange Commission (SEC). National and international quality organizations, such as International Organization for Standardization (ISO), require periodic quality audits to ensure the organization has well-defined internal quality monitoring processes and procedures linked to effective actions. The organization may use an audit to verify that part or all of the organization is following internal policies and standards.

The records of the organization may include information about one or more auditable items. An auditable item is a record or set of records that are required to be examined according to the set of regulations as part of the audit. Examples of auditable items are financial statements, billing records, quality records, purchase orders, and estimation reports. Typically audits are performed with the aid of computer software, due to the amount and complexity of information needed to perform an audit.

### SUMMARY

In a first principle aspect of the invention, a system is provided. The system comprises a processor, an input device, a display, and data storage. The data storage contains machine language instructions. The machine language instructions comprise instructions executable by the processor to: (i) on the display, display an audit-header checklist question of an audit checklist, (ii) from the input device, receive an audit-header answers to the audit-header checklist question, (iii) associate at least one auditable item with the audit checklist, based on the audit-header answer, (iv) on the display, display an audit-checklist question of the audit checklist, (v) from the input device, receive an answer to the audit-checklist question, and (vi) complete the audit checklist for the associated at least one auditable item, based on the audit-checklist answer.

In a second principle aspect of the invention, a method for auditing an auditable item is provided. The method involves generating an audit checklist. The audit checklists comprise an audit-header question and an audit-checklist question. One or more auditable items are associated with the audit checklist. Each audit checklist is completed for each auditable item. An audit score is calculated for each auditable item, where the audit score is based on the completed audit checklist for the auditable item. The auditable items are audited based on the audit score for the associated auditable item.

In a third principle aspect of the invention, a computerized method for generating one or audit reports is provided. An audit checklist is associated with one or more auditable items. Audit-checklist data is generated from the associated audit checklist. The generated audit-checklist data is stored in a data repository. The one or more audit reports are generated based on the stored audit-checklist data.

These as well as other aspects and advantages will become apparent to those of ordinary skill in the art by reading the following detailed description, with reference where appropriate to the accompanying drawings. Further, it should be understood that the embodiments described in this summary and elsewhere are intended to be examples only and do not necessarily limit the scope of the invention.

### BRIEF DESCRIPTION OF THE DRAWINGS

FIG. 1 is a block diagram of an example general auditing system, in accordance with an embodiment of the invention, in accordance with an embodiment of the invention.

FIG. 2 is a simplified block diagram of an example computing device, in accordance with an embodiment of the invention.

FIG. 3 is a simplified block diagram of an example internal procurement audit surveillance system (I-PASS), in accordance with an embodiment of the invention.

FIG. 4 is an example initial entry screen for I-PASS with an add audit button, a find/edit audit button, and a reports button, in accordance with an embodiment of the invention.

FIG. 5 depicts an example I-PASS screen with a form for answering questions in a PO audit-header-question portion, in accordance with an embodiment of the invention.

FIG. 6 shows an I-PASS screen with a form for answering questions of PO audit-checklist-question portion, as well as displaying answers to questions in PO audit-header-question portion, in accordance with an embodiment of the invention.

FIG. 7 shows an example of a comment entry dialog for entering in a comment to a question in PO audit-checklist-question portion and a comment display, in accordance with an embodiment of the invention.

FIG. 8 is an example summary report for an auditable item, in accordance with an embodiment of the invention.

FIG. 9 is a schematic view of an example data structure for storing answers to questions of a PO-audit checklist, in accordance with an embodiment of the invention.

FIG. 10 shows an example of an I-PASS initial audit report screen with an audit-report-type dialog, an audit-time-and-type dialog, a print button, and a close button, in accordance with an embodiment of the invention.

FIG. 11 is an example of an audit report, in accordance with an embodiment of the invention.

FIG. 12 shows an example of a textual audit report, in accordance with an embodiment of the invention.

FIG. 13 is a flowchart depicting an example of a method for auditing an auditable item, in accordance with an embodiment of the invention.

FIG. 14 is a flowchart depicting an example of a method for generating audit reports, in accordance with an embodiment of the invention.

Reference numerals are shown in the drawings to identify various elements of the drawings. Drawing elements having identical reference numerals are substantially identical or identical elements.

### DETAILED DESCRIPTION

1. Overview

A general auditing system is disclosed that permits the auditing of one or more auditable items to indicate compliance with a set of regulations. Computer software and/or computer hardware may be used to automate part or all of the general auditing system. The audit may be for any purpose, including a financial audit, a quality audit, or other type of audit guided by a set of regulations.

Using the general auditing system, an auditor or other person begins an audit by associating the one or more auditable items with one or more audit checklists. The one or more audit checklists comprise one or more questions, which may be derived from the set of regulations. The auditor completes each audit checklist by answering the questions of the audit checklist. Once the audit checklists are completed, one or more audit reports are generated based on the completed audit checklists.

2. The General Auditing System

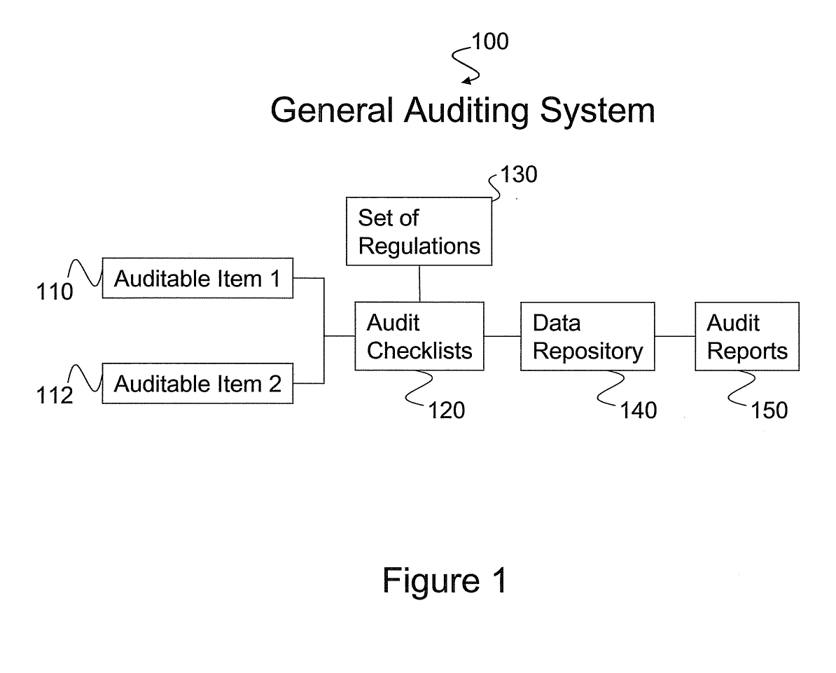

FIG. 1 is a block diagram of an example general auditing system 100, in accordance with an embodiment of the invention. The general auditing system 100 audits one or more auditable items 110 and 112 by associating one or more audit checklists 120 with the auditable items 110 and 112, completing the audit checklists 120 for the associated auditable items 110 and 115, and generating audit reports 150, which are based on the completed audit checklists 120, to report the results of the audit.

Each auditable item 110 and 112 is a record or set of records to be audited or examined. Some examples of auditable items 110 and 112 are purchase orders, bid estimates, billing records, quality records, and financial statements. The general auditing system 100 may be implemented by use of computer software running on a computing device.

As shown in FIG. 1, audits performed by the general auditing system 100 are based upon a set of regulations 130. Examples of the set of regulations 130 include Federal Acquisition Regulations (FAR), Defense Contract Management Agency (DCMA) regulations, Defense Contract Auditing Agency (DCAA) regulations, Sarbanes-Oxley (SOX) mandated regulations for financial reporting, ISO quality audit regulations, GAAP regulations, as well as other regulations, laws, and rules used for auditing auditable items. The set of regulations 130 also may include requirements termed “internal guidelines”; that is, policies and standards that are internal to an organization, such as corporate policy manuals. An audit checklist 120 based on internal guidelines may determine compliance to internal policies and standards and/or aid an internal audit of the organization.

Each of the audit checklists 120 comprise one or more audit-checklist questions. The audit-checklist questions may be written to indicate compliance with the set of regulations 130. The experience of the auditor creating an audit checklist 120 may aid determination of one or more specific questions on the audit checklist. The audit-checklist questions may comprise an audit-header-question portion and an audit-checklist-question portion.

Some or all of the audit-checklist questions may have a limited number of definite answers. In particular, limiting the answers of audit-checklist questions to answers of “Yes”, “No”, and “Not Applicable” is preferable for at least the reasons described below. Use of definite answers to audit-checklist questions requires less interpretation than use of auditing techniques that use indefinite answers (e.g,. textual explanations/reports or numerical and/or textual summaries of audit results).

The audit-checklist questions may depend on the requirements specified by the set of regulations. Therefore, by selecting a different audit checklist, a different type of audit is performed. The auditor or other person answering the audit-checklist questions may provide a comment to an answer to a audit-checklist question, in order to clarify, explain and/or otherwise add information about the answer, to remind the user of additional research or investigation required to answer an audit-checklist question, or for other reasons.

Unless otherwise stated, the term “discrepancy” is used herein to identify an audit-checklist question whose answer for an auditable item indicates the auditable item does not comply with the set of regulations 130. Unless otherwise stated, the term “opportunity” is used herein to identify an applicable audit-checklist question; that is an audit-checklist question whose answer for an auditable item is applicable to indicate compliance or non-compliance with the set of regulations 130.

The answers to audit-checklist questions for an audit checklist 120 may determine an audit score for the audit checklist 120. The audit score may be determined by weighting the audit-checklist questions. The weights for the audit-checklist questions may be uniform or non-uniform. An audit score determined on a weighted basis may assign weights or point values to each question based on the relative importance of the question being answered. For example, an audit-checklist question about violating a public law may be relatively more important (and thus have more weight) than an audit-checklist question ensuring no typographical errors are found in the auditable item.

Given a number of non-uniformly-weighted audit-checklist questions for an audit checklist, an non-uniformly-weighted audit score may be determined by: (i) determining a non-uniformly-weighted compliant-answer score by determining a sum of the weights of compliant answers to the audit-checklist questions, (ii) determining a non-uniformly-weighted opportunity score, which may be equal to a sum of the weights of applicable audit-checklist questions, and (iii) determining the non-uniformly-weighted audit score by determining a ratio of the non-uniformly-weighted compliant-answer score over the non-uniformly-weighted opportunity score. Given a number of uniformly-weighted audit-checklist questions for an audit checklist, a uniformly-weighted audit score for the audit checklist may be determined by: (i) determining a uniformly-weighted compliant-answer score, which may be equal to a number of compliant answers to the audit-checklist questions, (ii) determining a uniformly-weighted opportunity score, which may be equal to a number of applicable audit-checklist questions, and (iii) determining the uniformly-weighted audit score by determining a ratio of the uniformly-weighted compliant-answer score to the uniformly-weighted opportunity score.

An audit score for an audit checklist 120 may be determined simultaneously or nearly simultaneously with answering audit-checklist questions in audit checklist 120 and/or after answering the audit-checklist questions. An audit score may be determined so that a higher audit score indicates greater compliance with the set of regulations 130 than a lower audit score. Conversely, an audit score may be determined so that a higher audit score indicates more discrepancies and therefore lesser compliance with the set of regulations 130 than a lower audit score. The audit score may be expressed as a numerical value (e.g. 250 points), as a ratio (e.g. 250/300 points), as a percentage (e.g. 83%), a letter grade (e.g. a “B+”), a color-coded grade (e.g. audits with 90-100% compliance are green, audits with 80-90% compliance are yellow, and audits with less than 80% compliance are red) or as a combination of the above audit score expressions. Other audit score expressions are possible as well.

The questions in an audit checklist may be numbered. Portions of an audit checklist may be arranged so that all questions in a first portion of an audit checklist have lower numbers than all questions in a second portion of an audit checklist. A first audit-checklist question is termed to be “earlier” in an audit checklist than a second audit-checklist question if the first audit-checklist question has a number less than the second PO audit-checklist question. Similarly, the second audit-checklist question is termed to be “later” in the audit-checklist than the first audit-checklist question if the number of the second audit-checklist question is greater than the number of the first PO audit-checklist question. For example, if an audit-checklist has 10 questions, numbered 1-10, question number 1 is earlier than question number 2. Similarly, question number 2 is later than question number 1.

The results of completing the audit checklists 120 may be stored in a data repository 140 as audit-checklist data. The data repository 140 may comprise one or more computing devices equipped with data storage sufficient to hold audit-checklist data from one or more audit checklists for one or more auditable items.

An audit score may be determined and/or audit reports 150 may be generated on the stored audit-checklist data. An audit report 150 may be provided to an ultimate audit customer (e.g., one or more governmental agencies, external auditors, quality organizations, external auditors and/or other entities outside of the organization) to indicate compliance with the set of regulations 130.

An audit report 150 may be used as a “first pass technique”—that is, the audit report 150 may be generated before it is shown to the ultimate audit customer. Using an audit report as a “first pass” at looking through the records of one or more auditable items in the audit report, auditors may be able to detect and correct problems with the auditable items at an early stage. One method to correct problems with auditable item(s) is to provide training opportunities. Other methods to correct problems are available as well.

Using a first pass technique for an audit provides several efficiencies: identifying non-compliant areas before the ultimate audit customer is aware to allow early correction, addressing system problems by identifying training opportunities and training people as early as possible in the audit cycle, ensuring compliance with one or more regulations before an actual audit, and performing dry-run audits as needed before an actual audit which both minimizes surprises as well as allowing for correction before the audit. Other efficiencies are possible as well.

An audit report 150 may be used to identify training opportunities. For example, suppose an audit report is generated for all auditable items associated with a specific organization. Further suppose that the audit report indicates the specific organization has a relatively-low audit score when compared to other organizations being audited. A relatively-low audit score for the specific organization may indicate a problem with the auditable items associated with the specific organization. Then, an auditor or other person may correct the relatively-low audit score. One method of correcting the relatively-low audit score is scheduling training, such as training about the general audit system 100 and/or the set of regulations 130, for the specific organization to correct the relatively-low audit scores. Other methods of correcting a relatively-low audit score are possible as well.

3. An Example Computing Device

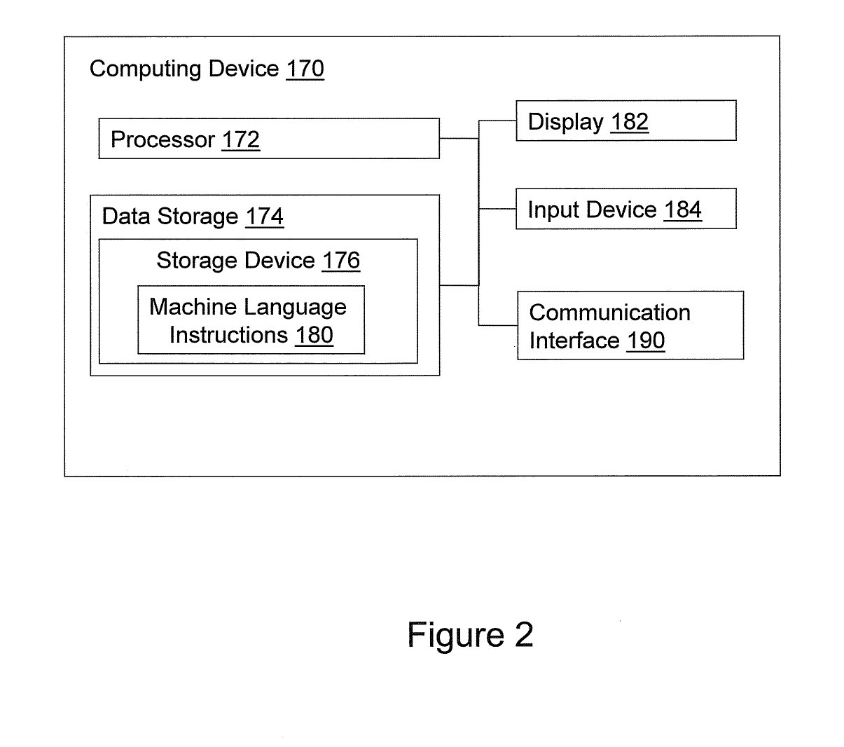

FIG. 2 shows a simplified block diagram of an example computing device 170, in accordance with an embodiment of the invention. An audit checklist 120 may be completed and/or a data repository 140 may be implemented with appropriately configured computer software on a computing device. The computing device 170 may be stationary or portable. A computing device 170 may be a desktop computer, laptop or notebook computer, personal data assistant (PDA), mobile phone, or any similar device that is portable and equipped with a processing unit capable of executing computer instructions that implement at least part of the herein-described methods 1300 and 1400 and/or herein-described functionality of I-PASS 300.

The computer software for the general auditing system 100 may comprise machine language instructions 180 executable on a processor 172 of computing device 170 and stored in data storage 175. The processor 172 may include one or more central processing units, computer processors, digital signal processors (DSPs), mobile processors, microprocessors, computer chips, and similar processing units now known or later developed that execute machine instructions and processes data.

As shown in FIG. 2, the components of computing device 170 may be coupled to permit processor 172 to control, communicate with, and use the other components of computing device 170, including, but not limited to, data storage 174, storage device 176, machine language instructions 180, display 182, input device 184, and communication interface 190.

Data storage 174 may comprise one or more storage devices 176. A storage device 176 may include read-only memory (ROM), random access memory (RAM), removable disk drive memory, hard disk memory, magnetic tape memory, flash memory, and similar storage devices now known or later developed. A storage device 176 may store machine language instructions 180.

The computing device 170 may have one or more displays 182, such as cathode-ray tubes (CRTs), liquid crystal displays (LCDs), light emitting diodes (LCD), a printer, and/or similar displays now known or later developed to display graphical, textual, and/or numerical information to a user of computing device 170. The computing device 170 may have one or more input devices 184, such as a computer mouse, track ball, one or more buttons, keyboard, keypad, touch screen, and similar input devices now known or later developed that permit the user to provide user input.

The computing device 170 may have one or more communication interfaces 190. The communication interface 190 may include a wired interface and/or a wireless interface. The communication interface 190 may comprise a device utilizing a wire, cable, fiber-optic link or similar physical connection to a wide area network (WAN), a local area network (LAN), one or more public data networks, such as the Internet, one or more private data networks, or any combination of such networks. The communication interface 190 may comprise a device utilizing an air interface to a wide area network (WAN), a local area network (LAN), one or more public data networks (e.g., the Internet), one or more private data networks, or any combination of public and private data networks.

4. The Internal Process Audit Surveillance System (I-PASS)

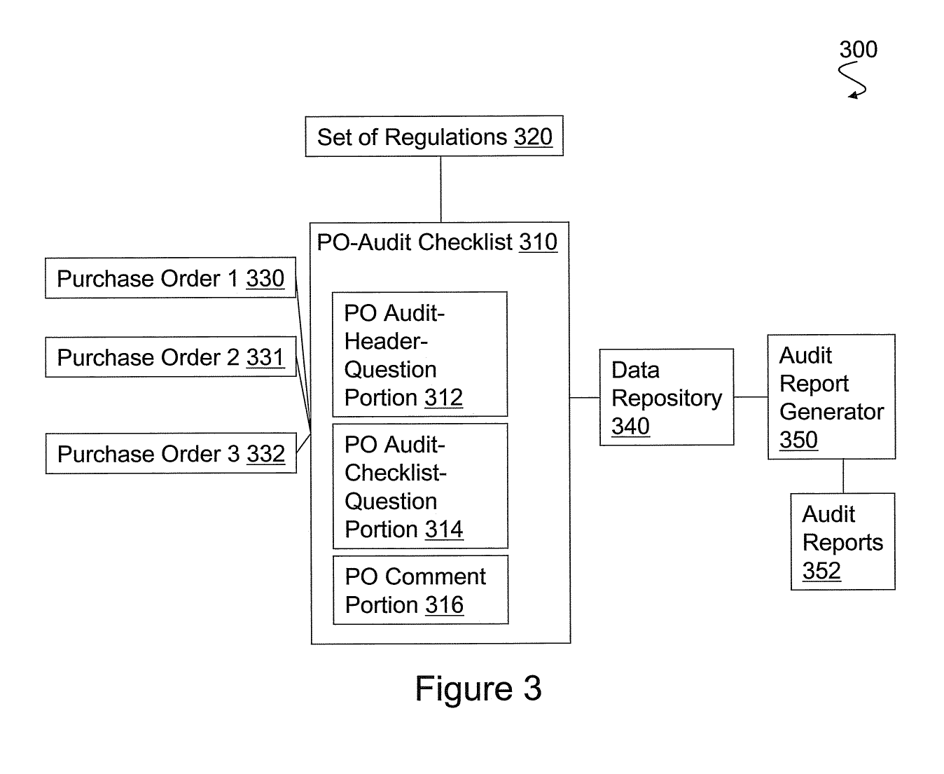

FIG. 3 is a simplified block diagram of an example internal procurement audit surveillance system (I-PASS) 300, in accordance with an embodiment of the invention. The I-PASS 300 may be an auditing system for ensuring an organization achieves compliance, including first pass compliance, with a set of regulations 320. The set of regulations 320 may include regulations under the Federal Acquisition Regulations (FAR), as well as Defense Contract Management Agency (DCMA) regulations, Defense Contract Auditing Agency (DCAA) regulations, and internal corporate auditing guidelines.

An auditor or other user of I-PASS 300 may write or update a PO-audit checklist 310 to ensure that one or more auditable items associated with the organization complies with a set of regulations 320. In the case of I-PASS, the auditable items may be purchase orders (POs) 330-332. 3The auditor may first examine the set of regulations 320 to determine how to ensure compliance. The auditor may write one or more audit-checklist questions of the PO audit-checklist 310 to ensure that POs 330-332 comply with the set of regulations 320.

In the case of I-PASS 300, each PO-audit checklist 310 may comprise a plurality of PO audit-checklist questions divided into at least two portions: a PO audit-header-question portion 312 and a PO audit-checklist-question portion 314. A user of I-PASS 300 may answer the audit-checklist questions. The PO-audit checklist 310 may have also a comments portion 316 to comment on answers to the PO audit-checklist questions.

The PO audit-header-question portion 312 may include questions that identify a purchase order, a contract associated with the purchase order, the dollar-amount of the contract, and other questions about the purchase order. Questions in the PO audit-header-question portion 312 may associate a particular purchase order with the PO-audit checklist 3 10.

Some or all of the questions in PO audit-checklist-question portion 314 may have a limited number of answers. Preferably, some or all of the questions in PO audit-checklist 310 are written using a “Yes”/“No”/“Not Applicable” (Y/N/N/A) convention. The Y/N/N/A convention indicates that a “Yes” answer to an audit-checklist question implies an auditable item complies with a set of regulations, a “No” answer to an audit-checklist question implies the auditable item has a discrepancy (does not comply) with the set of regulations, and a “Not Applicable” answer to a PO audit-checklist question implies the set of regulations is not applicable to the auditable item. For questions in PO audit-checklist-question 314 that follow the Y/N/N/A convention, a discrepancy is a question with a “No” answer for a PO and an opportunity is a question with either a “Yes” or “No” answer for the PO.

Writing PO audit-checklist questions using the Y/N/N/A convention may provide for an non-uniformly-weighted audit-score determination as follows: (i) for each “Yes” answer to a PO audit-checklist question for a given PO, both the compliant-answer score and the opportunity score may be increased by a weighting value of the PO audit-checklist question, (ii) for each “No” answer to a PO audit-checklist question for a given PO, the opportunity score may be increased by a weighting value of the PO audit-checklist question, and (iii) the non-uniformly-weighted audit score for a given PO may be determined as the ratio of the compliant-answer score to the opportunity score. Any PO audit-checklist questions with an answer of “Not Applicable” are not used in determining the non-uniformly-weighted audit score.

For example, assume there are 60 non-uniformly-weighted PO audit-checklist questions in a PO audit-checklist-portion in which all of the questions in the PO audit-checklist-portion use the Y/N/N/A convention. Assume weights are assigned to the questions in the PO audit-checklist-portion as follows:

20 one-point questions, each with a weight of one point,

20 two-point questions, each with a weight of two points, and

20 three-point questions, each with a weight of three points.

For a given PO, suppose all of the one-point questions are answered “Yes”, all of the two-point questions are answered “Yes”, five of the three-point questions are answered “Yes”, and 15 are answered “No.” Then, the compliant-answer score for the given PO would be: 20 points for the one-point questions+40 points for the two-point questions+15 points for the three-point questions=75. The opportunity score for the given PO would be: 20 points for the one-point questions+40 points for the two-point questions+60 points for the three-point questions=120. Then, the non-uniformly-weighted audit score for the given PO would be 75/120=0.625 or, expressed as a percentage, 62.5%.

In the case of uniformly-weighted audit-checklist questions using the Y/N/N/A convention, the non-uniformly-weighted audit-score technique may be used to determine a uniformly-weighted audit score by setting a weighting value for each audit-checklist question to a uniform weight, such as a weight of one point.

For example, assume there are 60 uniformly-weighted PO audit-checklist questions that use the Y/N/N/A convention in an PO-audit-checklist-portion and that the PO audit-checklist questions are uniformly weighted with a weight for each question is one point. For a given PO, further assume 45 of the PO audit-checklist questions were answered “Yes,” and 15 were answered “No.” For the given PO, the compliant-answer score would be 45, the opportunity score would be 60, and the uniformly-weighted audit score for the given PO would be 45/60=0.75, or expressed as a percentage, 75%.

The POs 330-332 may be the result of an award of a contract. For example, a contracting organization, such as a governmental agency, corporation, person or other entity, may inform the organization of a contract to be signed. In response to the information about the contract, the organization may bid on the contract. In response to the bid, the contracting organization may award the contract to the organization. The organization may be required to purchase one or more items to fulfill the awarded contract. The POs 330-332 may be generated to track the purchases of the items required by the awarded contract.

The answers to the audit-checklist questions may be stored in data storage of data repository 340. FIG. 2 shows data repository 340 as part of I-PASS 300. The data repository 340 may be computer software and/or hardware that performs the tasks of the data repository described herein.

An audit report 352 may be generated by audit report generator 350 based on the stored answers to the PO audit-checklist questions of the PO-audit checklist 310. The audit report generator 350 may be configured to retrieve stored answers to the PO-audit checklist questions from data repository 340. A generated audit report may be displayed on a display of a computing device, printed, transmitted as data, faxed, stored in data storage of the computing device, or otherwise processed by the computing device.

A prototype audit checklist may be developed. The prototype audit checklist may be developed in a prototyping environment. The prototyping environment may allow a person testing and/or developing the prototype audit checklist to perform some or all tasks a user of I-PASS 300 would perform in using the prototype audit checklist. The prototyping environment may permit a user of I-PASS 300 to store the answers to PO audit-checklist questions on a portable computing device. Once the PO audit-checklist questions are answered and stored on the portable computing device, the stored answers may be transmitted (uploaded) from the portable computing device to the I-PASS 300 and/or stored in data repository 340. A preferable prototyping environment is the Microsoft Excel 2002 spreadsheet program (“MS Excel”). However, a similar spreadsheet program and/or other software may act as the prototyping environment.

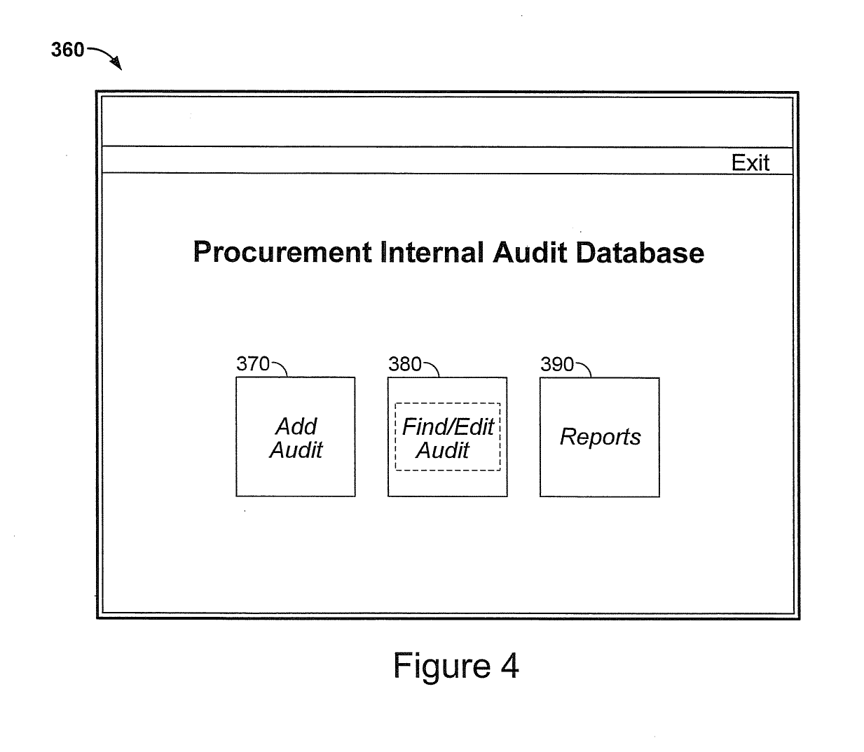

FIG. 4 is an example initial entry screen 360 for I-PASS 300 with an add audit button 370, a find/edit audit button 380, and a reports button 390, in accordance with an embodiment of the invention. The initial entry screen 360 may comprise one or more buttons to allow a user to select a function of I-PASS 300. As shown in FIG. 4, the initial entry screen 360 has three buttons. The add audit button 370 may create a new audit. The find/edit audit button 380 may allow for searching and potentially changing an audit. The reports button 390 may allow the generation of one or more audit reports, which can later be transmitted and/or printed.

I-PASS 300 may comprise computer software and/or computer hardware to (i) display initial entry screen 360 and/or other I-PASS dialogs, screens and forms described herein and/or (ii) accept input entered in on initial entry screen 360 and/or other I-PASS dialogs, screens and forms described herein. A web-browser interface to I-PASS 300 may supplement or be an alternative to initial entry screen 360 and/or other I-PASS screens described herein. The web browser interface may be displayed using a web browser, such as Microsoft Internet Explorer (IE), Mozilla Firefox, Opera, or a similar web browser that is operable to display the web page(s) of the web browser interface to I-PASS 300. The web-browser interface may be implemented using one or more web pages written in a web browser language, such as the Hypertext Markup Language (HTML). A secure web interface to I-PASS 300 may be provided via secure hypertext links (a.k.a. HTTPS links) or other similar means of providing secure web connections.

Preferably, the web pages look and act the same as (or substantially similar to) the I-PASS screens, dialogs, and forms shown herein, to minimize web-browser-interface-related errors and training. The web pages may accept, via the web browser, user input from a user of I-PASS 300, including but not limited to answers to audit-checklist questions, comments on audit-checklist questions, selection of I-PASS functions, and/or input used in generating audit reports. The web pages may display, via the web browser, output of I-PASS 300, including but limited to audit-checklist questions, answers to audit-checklist questions, comments on audit-checklist questions, audit scores, and/or audit reports.

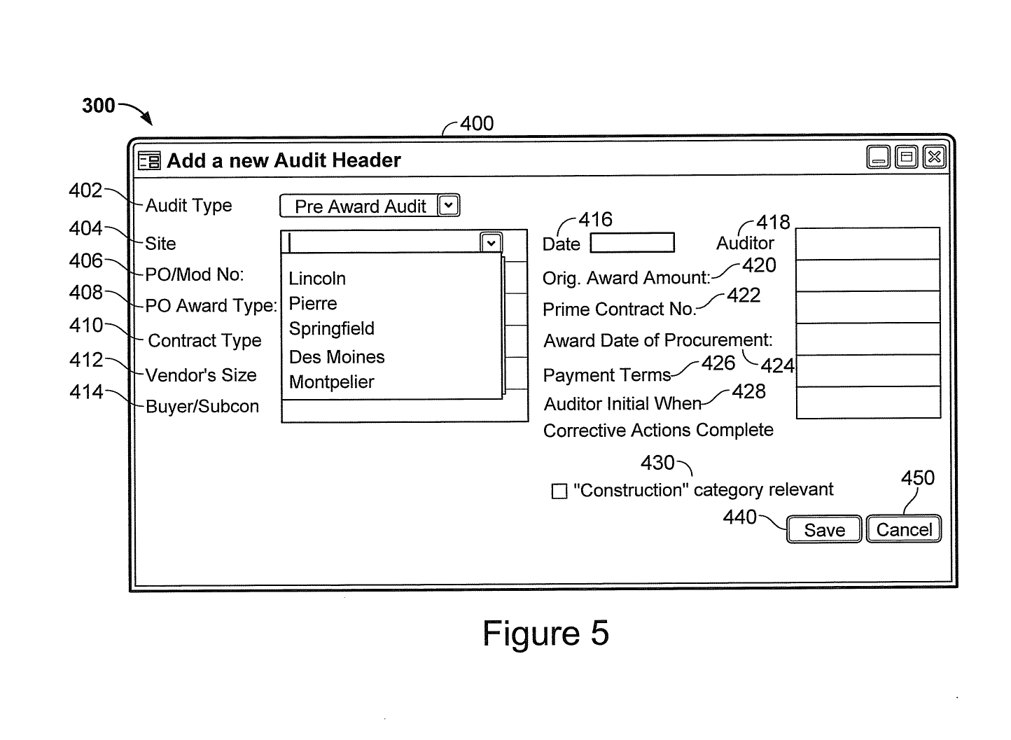

FIG. 5 depicts an example I-PASS screen with a form 400 for answering questions in the PO audit-header-question portion 312, in accordance with an embodiment of the invention. The questions in PO audit-header-question portion 312 may comprise an audit type question 402, a site question 404, a PO/Mod number question 406, a PO award type question 408, and a contract type question 410. The audit type question 402 determines the type of audit to be performed. The site question 404 indicates the site or location for the purchase order. As shown in FIG. 5, a pull down menu indicates various possible locations. Pull-down menus may aid answering the questions in PO audit-header-question portion 312. The PO/Mod number question 406 identifies the purchase order number.

An auditable item may be associated with an audit checklist based on one or more answers to one or more questions in PO audit-header-question portion 312. For example, suppose that a given PO has an identifier of 1234567. Then, an auditor may provide an answer to PO/Mod number question 406 of “1234567” for the given PO. In this case, the answer “1234567” to the PO/Mod number question 406 associates PO-audit checklist 310 with the given PO. Other PO audit-header questions may associate a PO with a PO-audit checklist as well.

The PO Award Type question 408 indicates the type of purchase order. The contract type question 410 indicates a type of contract (e.g., cost plus or fixed price) under which the purchase order was generated.

The questions in PO audit-header-question portion 312 may comprise questions about the size of the vendor 412 and the name of the buyer or subcontractor 414. The date question 416 may be answered by entering in a date when the audit occurred. The auditor question 418 may be answered by entering in the initials or name of the auditor (or other user of I-PASS 300) answering the questions of PO-audit checklist 310.

The original award amount question 420 may be answered with a dollar-amount of an original award for a contract associated with the purchase order. The answer to the original award amount question 422 may determine the answers to questions in the PO audit-checklist questions 314. For example, certain FAR procedures are applicable only if the original award amount is greater than $10,000. If the original award amount question 420 is answered with a value under $10,000, several of the PO audit-checklist questions in PO audit-checklist question segment 314 may be “automatically answered” (i.e. the answers were determined by I-PASS 300) as “N/A” (not applicable), as those questions concern the FAR procedures followed for original award amounts greater than $10,000. Other questions about the original contract are also part of PO audit-header-question portion 312, such as the prime contract number question 422, award date of procurement 424, and payment terms 426.

When an audit is first run, the auditor may find one or more differences between the requirements of the FAR and the actions taken in executing a given purchase order. When appropriate corrective actions have been taken to meet the requirements of the FAR for the given purchase order, the user of I-PASS 300 can enter their initials or other identifier, such as the name of the user, as completion initials 450.

If construction is involved in the purchase order, the auditor may indicate construction is relevant by use of construction relevant checkbox 430. The construction relevant checkbox may be useful, as the FAR has certain procedures followed only when a purchase order involves construction as defined by the FAR. Finally, the auditor can click on a save button 440 to save any answers to the PO audit-header questions entered into of form 400 or a cancel button 450 to exit form 400 without saving the answers to the PO audit-header questions.

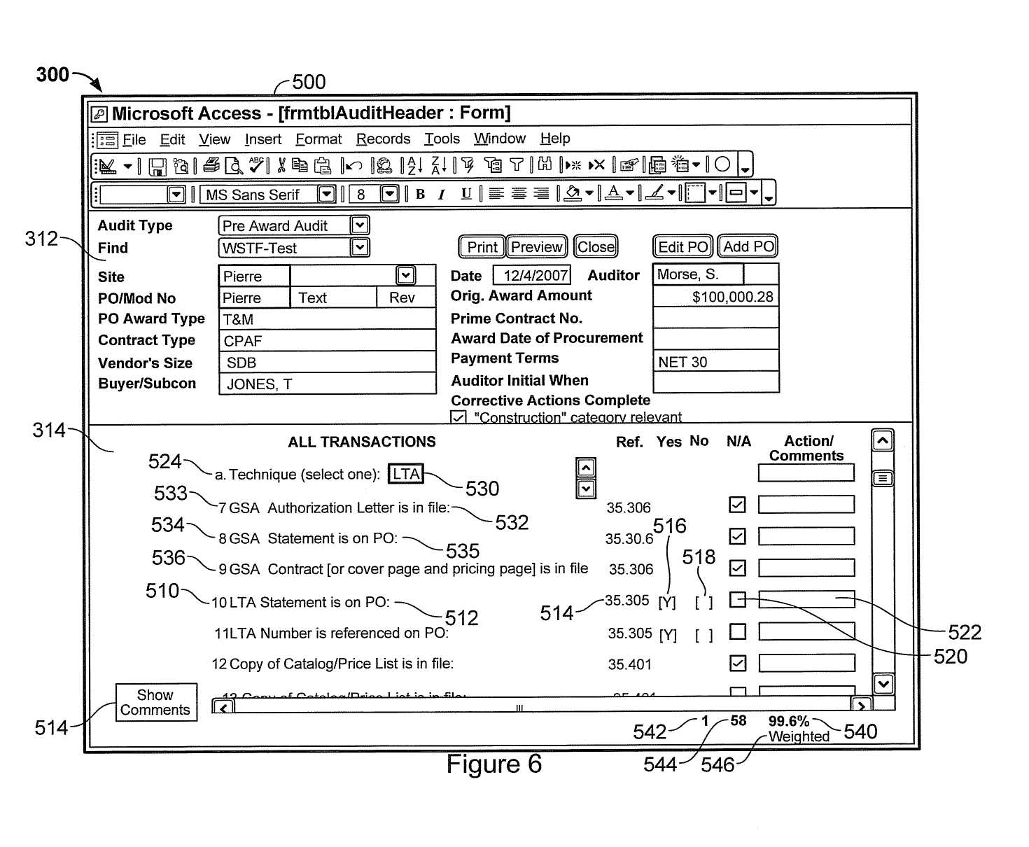

FIG. 6 shows an I-PASS screen with a form 500 for answering questions of PO audit-checklist-question portion 314, as well as displaying answers to questions in PO audit-header-question portion 312, in accordance with an embodiment of the invention. A question in PO audit-checklist-question portion 314 may comprise question text, a regulation reference, a “Yes” answer box, a “No” answer box, an “N/A” (“Not Applicable”) answer box, and a comment field. FIG. 6 shows a question 510 in PO audit-checklist-question portion 314 is shown with a number of “10”, question text 512 of “LTA Statement is on PO”, a regulation reference 514 of “35.305”, a “Yes” answer box 516 with a “Y”, “No” and “N/A” answer boxes 518 and 520 with nothing shown inside the answer boxes, and no comments indicated in a comment field 522.

The regulation reference 514 is provided to give the user of I-PASS 300 a source of a question in PO audit-checklist-question portion 314. The regulation reference 514 may be a text reference, a hypertext or similar link to a reference volume, or both. I-PASS 300 and/or software implementing form 500 may enforce a rule that only one of the “Yes” answer box 516, “No” answer box 518, or “N/A” answer box 510 may be selected for a question in PO audit-checklist-question portion 314.

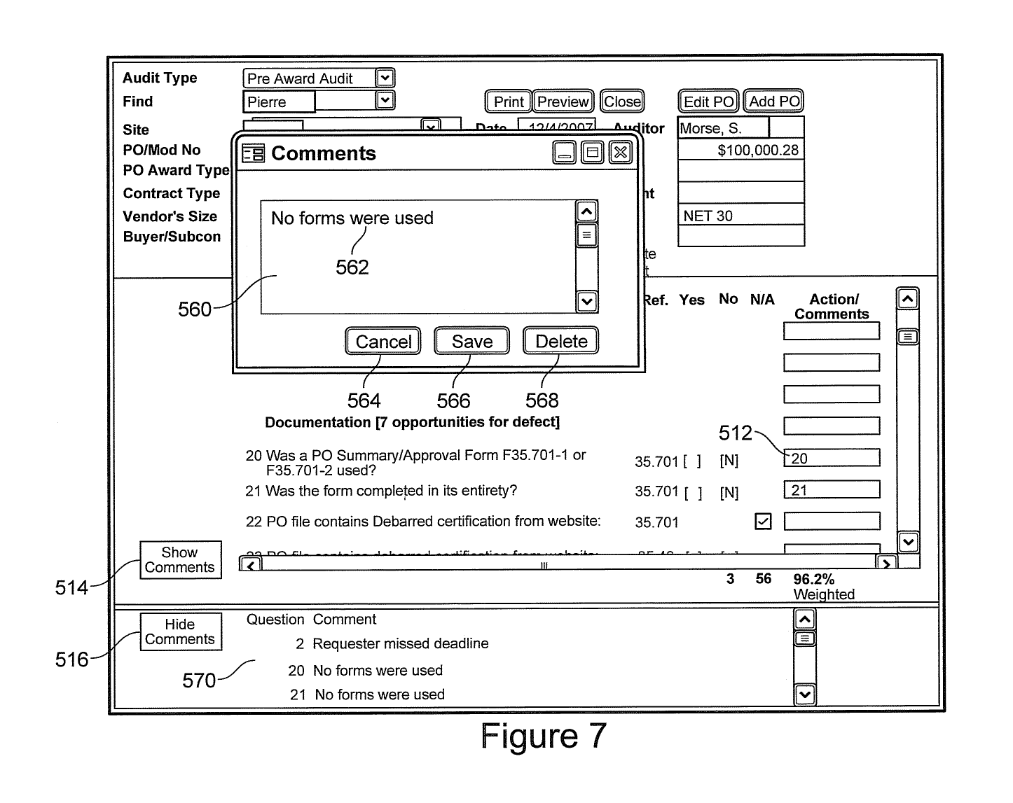

FIG. 7 shows an example of a comment entry dialog 560 for entering in a comment to a question in PO audit-checklist-question portion 314 and a comment display 570, in accordance with an embodiment of the invention.

A user of I-PASS 300 may provide comments to an answer of a question in PO audit-checklist-question portion 314. The comment display 570 may be displayed in response to a user of I-PASS 300 clicking on show comments button 514. FIG. 7 shows comment display 570 with comments for PO audit-checklist questions two, twenty, and twenty-one. If the user of I-PASS 300 selects hide comment button 516, the comment display 570 may be hidden from view of the user of I-PASS 300.

Comment field 512 may indicate a comment with comment text and/or a comment reference. FIG. 7 shows an example of the comment field 512 of question #20 in PO audit-checklist-question portion 314 indicating a comment with a comment reference “20” for question #20 in PO audit-checklist-question portion 314. The comment display 570 shows that the comment text for question #20 in PO audit-checklist-question portion 314 is “No forms were used.”

The comment entry dialog 560 may input and/or modify comment text. The comment entry dialog 560 comprises a comment text entry field 562, a cancel button 564, a save button 566, and a delete button 568. In response to a selection of cancel button 564, save button 566, or delete button 568, I-PASS 300 respectively discards the comment, saves the comment, or deletes the comment. In response to the selection of a comment dialog button 564-568, I-PASS 300 may close comment entry dialog 560.

Returning to FIG. 6, a question 524 in PO audit-checklist-question portion 314 has an answer 530 of “LTA.” An PO-audit checklist may be structured so that an answer to an earlier question may determine an answer to a later question in PO audit-checklist-question portion 314. Further, I-PASS 300 may indicate to a user that an answer to an earlier question has determined an answer to a later question of PO audit-checklist-question portion 314. Based on the answer 530 of “LTA” to earlier question 524, the answers to later questions 532, 534, and 536 in PO audit-checklist-question portion 314 have been automatically answered as “N/A.” FIG. 6 shows “N/A” answers as checkmarks in the N/A answer boxes for each of questions 532, 534, and 536.

To aid the user of I-PASS 300, the question text of a question in PO audit-checklist-question portion 314 answered as “Not Applicable” may be displayed in a different manner than question text for a question in PO audit-checklist-question portion 314 not answered as “Not Applicable.” For example, as may be seen in FIG. 6, each question 532, 534, and 536 have been answered “Not Applicable” and each of questions 500 and 520 have been answered as “LTA” and “Yes” respectively. As such, FIG. 6 shows the comment text of questions 532, 534, and 536 displayed in gray and the comment text of questions 500 and 520 displayed in black.

I-PASS 300 may indicate one or more audit-checklist questions have been automatically answered by any combination of user-interface techniques, including: filling in the determined answers for the automatically answered questions, changing the display of the automatically answered questions, generating one or more pop-up windows indicating the questions have been automatically answered, removing the automatically answered questions from the PO-audit checklist, or otherwise indicating that the questions have been automatically answered.

The questions in PO audit-checklist-question portion 314 may be scored by determining an audit score for the PO audit-checklist 310. An audit score for questions in PO audit-checklist-question portion 314 may be determined interactively as questions are answered and/or upon a specific request by a user of I-PASS 300. The audit score may be expressed as a ratio or a percentage. FIG. 6 shows the audit score 540 of 99.6% calculated based on one “No” response 542 out of fifty-eight opportunities 544.

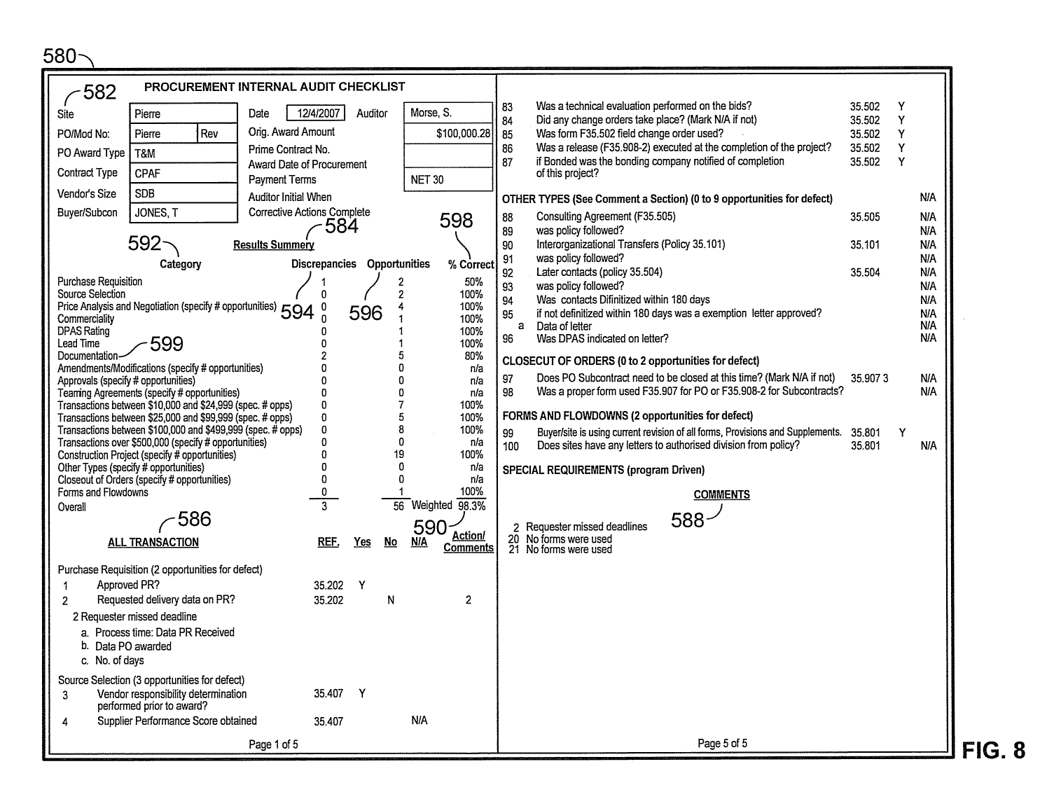

FIG. 8 is an example summary report 580 for an auditable item, in accordance with an embodiment of the invention. The summary report 580 may be generated on demand and/or upon answering the questions in the PO-audit checklist 310. The summary report 580 may comprise various sections to indicate the answers to questions in the PO-audit checklist 310 for the auditable item. FIG. 8 shows summary report 580 with PO audit-header question section 582, results section 584, PO audit-checklist question section 586, and comments section 588. Summary report 580 may comprise question text of PO audit-checklist questions of PO-audit checklist 310 and/or answers provided for a PO. FIG. 8 shows PO audit-header question section 582 and PO audit-checklist question section 586 with the question text and provided answers for questions in PO audit-header-question portion 312 and in PO audit-header-question portion 314, respectively. FIG. 8 shows comment section 588 indicating comments for three questions.

The summary report 580 may comprise a section for audit results. FIG. 8 shows results section 584 indicating the audit score 590 for the auditable item, as well as a results sub-section. The results sub-section comprises a category 592, a number of discrepancies 594, a number of opportunities 596, and a percentage correct value 598. FIG. 8 shows, as an example, a documentation category 599, where the category 592 is “Documentation,” the number of discrepancies 594 indicates two discrepancies were found between requirements in the set of regulations 320 and actions taken in executing the PO. Further, documentation category 599 has the number of opportunities 596 equal to five, indicating there are five opportunities for corrective action, and a 6.0% value of the percentage correct value 588.

5. Example Data Structure for Storing Answers to Audit-Checklist Questions

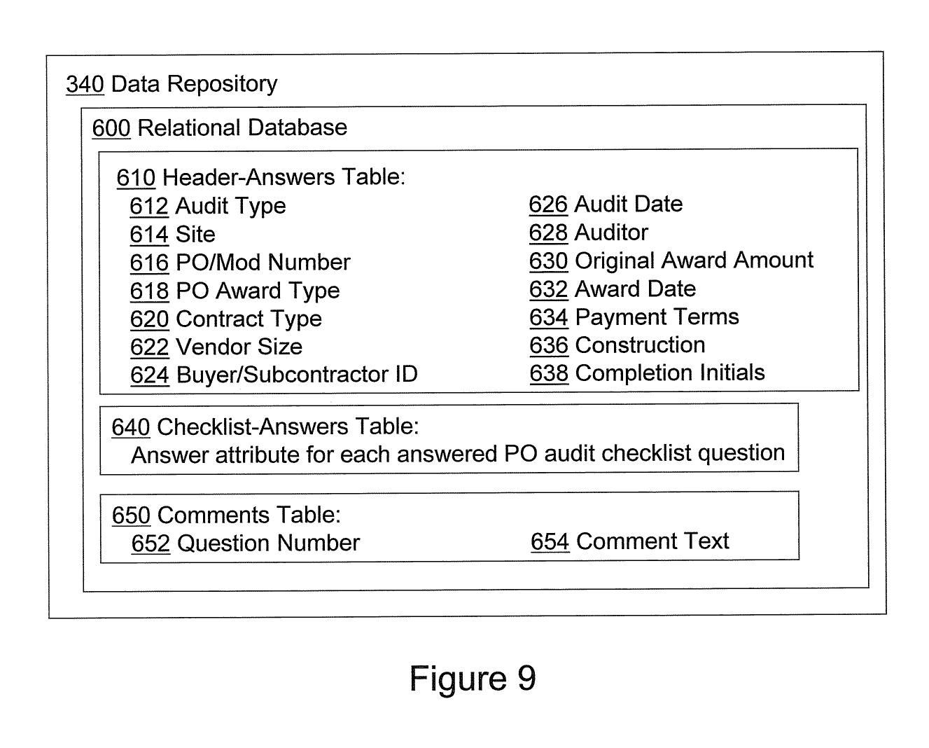

FIG. 9 is a schematic view of an example data structure for storing answers to questions of PO-audit checklist 310, in accordance with an embodiment of the invention. I-PASS 300 may store the answers to questions of PO-audit checklist 310 as audit-checklist data. I-PASS 300 may send audit-checklist data and/or data repository 340 may receive audit-checklist data from I-PASS 300 via communication interface 190. Once received, the audit-checklist data may be stored in the data repository 340. The data repository 340 may store the audit-checklist data in a data structure, such as a relational database 600 or similar data structure (e.g., a linked list, a trie, a table such as a lookup table or a hash table, or tree) now known or later developed operable to store the answers and retrieve the answers upon receipt of a query. The relational database 600 is preferably managed using the Microsoft Access 2002 relational database management system (RDBMS) (“MS Access”), but the relational database 600 may also be managed using the Microsoft MS SQL Server RDBMS, MS Excel, or other suitable software package.

The computing device 200 may send the answers to questions of PO-audit checklist 310 to the data repository 340. The answers to questions of PO-audit checklist 310 may be sent to the data repository upon a determination of: an expiration of a fixed interval of time, upon request from the data repository, and/or upon determination that storage size of the generated audit-checklist data has exceeded a data-storage threshold. The answers to questions of PO-audit checklist 310 may be sent due to any combinations of the determinations listed above. Other determinations are possible as well.

The relational database 600 may store audit-checklist data in one or more tables. As shown in FIG. 9, the audit-checklist data may be stored in three tables:

1. a header-answers table 610, for storing the answers to the questions of PO audit-header-question portion 312;

2. a checklist-answers table 640, for storing the answers to the questions of PO audit-checklist-question portion 314; and

3. a comments table 650, for storing comments on audit-checklist questions.

The header-answers table 610 may comprise attributes capable of storing at least the answers to the questions of PO audit-header-question portion 312. The header-answers table 610 may comprise attributes to store values that include, but are not limited to: an audit type 612, a site 614, a PO/Mod number 616, a PO Award Type 618, a contract type 620, a vendor size 622, a buyer/subcontractor identifier (ID) 624, an audit date 626, an auditor 628, an original award amount 630, an award date 632, payment terms 634, a construction relevant checkbox 636 and completion initials 638.

The checklist-answers table 640 may comprise attributes capable of storing all of the answers to the questions of PO audit-checklist-question portion 314. Preferably, each answered question in PO audit-checklist-question portion 314 follows the Y/N/N/A convention. However, it is to be understood that a question in PO audit-checklist-question portion 314 may have other answers than “Yes”, “No”, or “Not Applicable”.

The checklist-answers table 640 may have an answer attribute for storing each answer to each question in PO audit-checklist-question portion 314. The answer attribute may store an answer as a textual or a numerical value. Examples of textual values for answers are: a “Y” or “Yes” textual value for a “Yes” answer, a “N” or “No” textual value for a “No” answer, and a “A” or “N/A” textual value for a “Not Applicable” answer. Examples numerical values for answers are: a 0 for a “No” answer, a 1 for a “Yes” answer, and a 2 for a “Not Applicable” answer. It is to be understood that other textual and/or numerical values may be used to store answers in the checklist-answers table 640 and other storage schemes for checklist-answers table 640 are possible.

The comments table 650 may store comments made by a user on the audit checklist. The comments may have been made concerning an audit-checklist question. The comment table 650 may have a question number attribute 652 for storing a question number of a PO audit-checklist question 314 with a comment. The comment answers table 650 may store text of a comment in a comments text attribute 654. Any or all alphanumeric data, including but not limited to attributes in relational database 600 such as question number attribute 652 and/or comment text attribute 654, may be stored in alphanumerical form (e.g. in ASCII, EBCDIC, Unicode, or similar encoding form for alphabetic, pictographic and/or numerical characters). Other formats for storing audit-checklist data are possible as well.

6. Generating Audit Reports

One or more audit reports may be generated based on the stored answers in the data repository 340. The audit reports may be generated by an audit report generator 350. The audit report generator 350 may use one or more database queries to data repository 340 to retrieve the stored audit-checklist data. The database queries may be made using a query language, such as Transact-SQL. Alternatively, if the stored audit-checklist data is not stored in a database (such as a relational database), the audit report generator may use a different type of query, such as executing one or more query commands to retrieve the stored audit-checklist data (e.g., execute a script containing query commands or execute function or procedure calls to retrieve data from a linked list, hash table and/or lookup table). The audit report generator 350 may include some or all of the user input in the database queries, such as including timespan information provided via user input in the database queries.

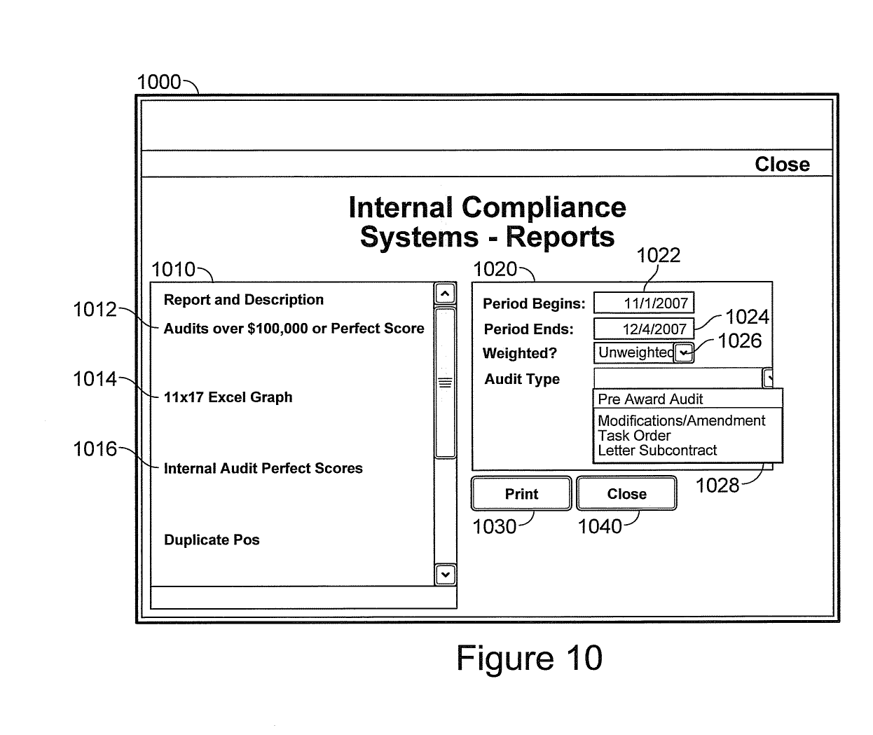

FIG. 10 shows an example of an I-PASS initial audit report screen 1000 with an audit-report-type dialog 1010, an audit-time-and-type dialog 1020, a print button 1030, and a close button 1040, in accordance with an embodiment of the invention. The audit-report-type dialog 1010 may be used to determine an audit report type for an audit. The audit-report-type dialog 1010 may permit an audit-report-type selection by a user of I-PASS 300 to generate audit reports based at least in part on the selection. The print button 1030 may allow a user of I-PASS 300 to print an audit report. The close button 1040 may allow a user of I-PASS 300 close the I-PASS initial audit report screen 1000.

User input may be provided to audit report generator 350 to generate the audit reports. For example, the audit-report-type dialog 1010 may permit an audit-report-type selection to generate an audit report that is: (i) filtered to choose auditable item(s) based on a dollar-amount, (ii) in a particular output format, or (iii) filtered to choose auditable item(s) based on an audit-score. FIG. 10 shows a dollar-amount selection 1012 in the audit-report-type dialog 1010. The dollar-amount selection 1012 to generate an audit report of selected auditable items, where each selected auditable item has a dollar-amount over $100,000. FIG. 10 also shows an output format selection 1014 that may generate an audit report on an MS Excel spreadsheet that may be printed on 11 inch by 17 inch paper, as well as an audit score selection 1016 to generate an audit report of selected auditable items, where each selected auditable item has a perfect audit score.

Other audit reports may be generated as well, such as but not limited to, audit reports filtered to choose auditable items(s) on a name or other identifier of a buyer/subcontractor basis, on a per auditable item basis, on a particular location or site basis, on a particular contract or PO basis, on predefined criteria (i.e. as specified in a set of regulations) for a compliance report, or an on-track percentage basis.

The audit-time-and-type dialog 1020 may permit a user of I-PASS 300 to select a timespan for an audit report, select a weighted or non-weighted audit report, and/or an award-type for an audit report. The values of a beginning period selection 1022 and an ending period selection 1024 may determine the timespan for an audit report. FIG. 10 shows selection of a timespan for an audit report with a beginning period selection 1022 of “Nov. 1, 2007” and an ending period selection 1024 of “Dec. 4, 2007.” User input may be provided to perform other or additional selections and/or provide additional data (e.g., location of stored audit-checklist data).

A user of I-PASS 300 may select a uniformly-weighted or a non-uniformly-weighted audit report using weighted-report selection 1026. A non-uniformly-weighted audit report is selected by setting the weighted-report selection 1026 to “Weighted”. Similarly, a uniformly-weighted audit report is selected by setting the weighted-report selection 1026 to “Non-weighted”.

A user of I-PASS 300 may select an audit-type for an audit report using award-type selector 1028. The format and contents of an audit report may depend on an award-type for the audit report. The award-type may depend on a type of an award of a contract to the organization. Example award-types are pre-award (i.e. in preparation for a bid on a contract), a modification of an award, a task order for an award, and a sub-contract award. As shown in FIG. 10, the award-type selector 1028 permits a user of I-PASS to select an award-type from the choices of “Pre award audit”, “Modification/amendment”, “Task Order”, and “Letter Subcontract.” Other user input to the audit report generator 350 for generating audit reports is possible as well.

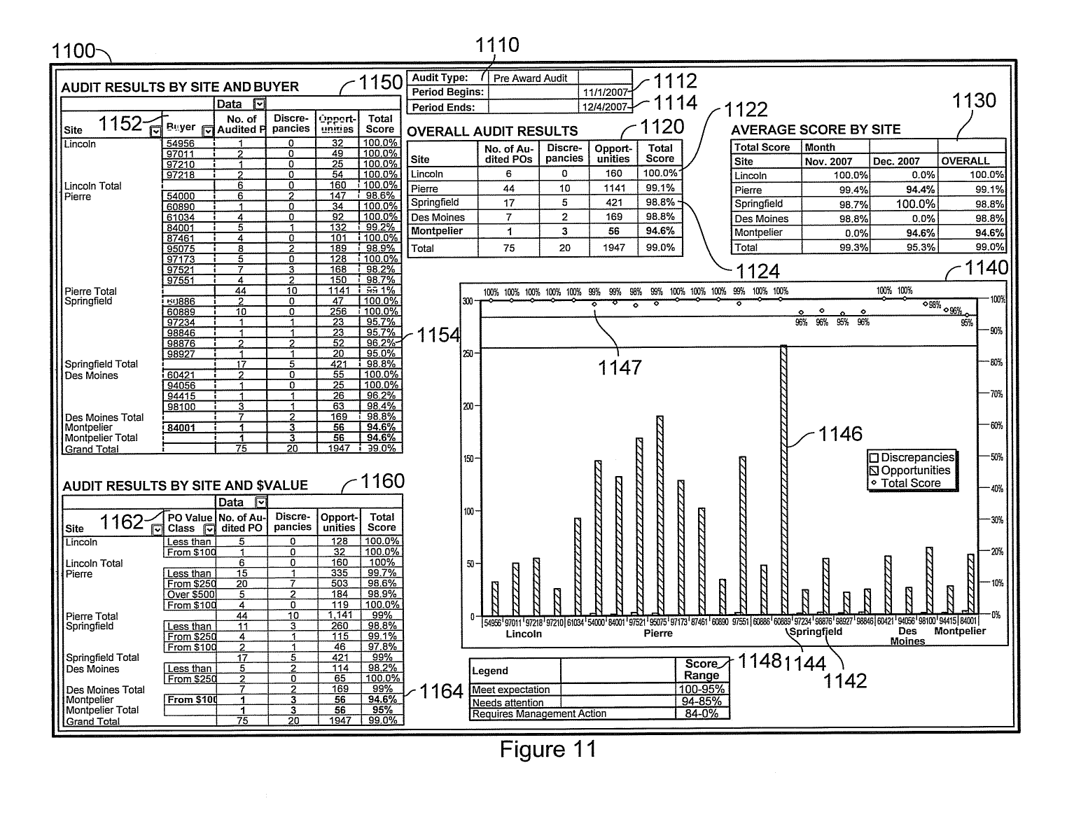

FIG. 11 is an example of an audit report 1100, in accordance with an embodiment of the invention. An audit report may comprise general-audit-report information, such as audit-type and date information, and/or audit sub-reports. The audit report 1100 indicates an audit-type 1110, a beginning audit-report-date 1112, an ending audit-report-date 1114, overall audit sub-report 1120, by-site audit sub-report 1130, by-site-and-buyer graphical audit sub-report 1140 with a legend 1148, by-site-and-buyer audit sub-report 1150, and by-site-and-dollar-value audit sub-report 1160. The audit report 1100 may be generated using audit report generator 350.

An audit report may report information using various selection criteria. For example, audit reports may report information selected using one selection criterion, such as reporting information on a per-site, per-agent (e.g., per-buyer), per-dollar-amount or per-auditable-item fashion. A selection criterion may be a single class of values, such as a site, or a class indicating a range of values, such as a dollar-range of $25,000 to $100,000 or audit-score-range of 95-100%. A selection criterion also may indicate a single member in a class of values, such a specific site or agent name. Further, audit reports may report information selected using a plurality of criteria, such as per-site-and-buyer or per-site-and-dollar-range criteria.

The audit-type 1110 may indicate the type of audit being reported. As shown in FIG. 11, the audit report 1100 is a pre-award audit as indicated by the audit-type 1110 of “Pre Award Audit”. Other example audit-types are modification of an award, a task order of an award, and a sub-contract award. It is to be understood that other audit-types are possible as well.

The beginning audit-report-date 1112 and the ending audit-report-date 1114 are the first and last dates, respectively, of the audit report. Activities for an auditable item may be reported in audit report 1100, such as creation, changing, or removal of the auditable item that occurred between the beginning audit-report-date 1112 and the ending audit-report-date 1114. User input may specify the audit-type 1110, the beginning audit-report-date 1112 and/or the ending audit-report-date 1114. Alternatively, the audit-type 1110, the beginning audit-report-date 1112 and/or the ending audit-report-date 1114 may be determined automatically (i.e., by execution of a script that requests the generation of audit report 1100 periodically for a given audit-type 1110).

Audit reports may be textual, graphical, or both textual and graphical. For example, FIG. 11 shows overall audit sub-report 1120, by-site audit sub-report 1130, by-site-and-buyer audit sub-report 1150, and by-site-and-dollar-value audit sub-report 1160 are textual audit reports, using alphanumeric data to indicate audit results. FIG. 11 also shows by-site-and-buyer graphical audit sub-report 1140 is a graphical audit report using a bar graph to indicate audit results.

Graphical qualities, such as background shading, may provide additional information to a textual audit report. FIG. 11 shows legend 1148 indicating the use of background shading to indicate of score ranges, wherein a relatively-light shade of gray indicates a score range of 95-100% entitled “Meet expectation,” a relatively-dark shade of gray indicates a score range of 85-94% entitled “Needs attention,” and a black shade indicate a score range of less than 85% entitled “Requires Management Action.” It is to be understood that more or fewer score ranges, as well as score ranges with different numerical values and/or titles could be used, with more or fewer shades to be used.

FIG. 11 shows by-site-and-buyer audit sub-report row 1154 in a relatively-light shade of gray as the audit score of 96.3% of the by-site-and-buyer audit sub-report row 1154 is in the 95-100% score range. FIG. 11 displays by-site-and-dollar-value audit sub-report row 1164 in a relatively-dark shade of gray as the audit score of 94.6% of the by-site-and-dollar-value audit sub-report row 1164 is in the 85-94% score range. It is to be understood that other graphical qualities, such as but not limited to type font, size, background color, foreground color/shading, and/or background texture, may be used to provide additional information to a textual audit report as well.

Score ranges may identify responses for some audit scores. For example, audit scores in the “Needs Attention” score range of 85-94% for an auditable item at a particular site by a particular buyer may identify a response of starting (or increasing) training at the particular site and/or for the particular buyer. A score range in the “Requires Management Attention” score range of less than 85% may indicate a failure in one or more systems, such as financial reporting, controls, computer hardware and/or software, and the like. The response in for auditable items in the score range of less than 85% may be to investigate the cause(s) of the audit score, determine if and/or where any systems failed to cause the audit score, and/or to repair any failed systems. Other responses are possible as well.

Alphanumeric data, such as audit scores, may provide additional information to a graphical audit report. For example, a numerical indicator 1147 is shown on the by-site-and-buyer graph 1140. Numerical indicator 1147 provides an audit score value for buyer “54000” at site “Pierre.” As shown in FIG. 11, numerical indicator 1147 is “99%”. Other alphanumeric data may provide additional information to a graphical audit report as well.

The overall audit sub-report 1120 may indicate results for all auditable items reported in the audit report. Overall audit sub-report 1120 may be determined on a per-site or other basis. On a per-site or other basis, overall audit sub-report 1120 may include a number of audited auditable items, the number of discrepancies among the audited auditable items, the number of opportunities for the audited auditable items, and a total score for the site. As shown in FIG. 11, the overall audit sub-report 1120 has a header row 1122. The header row 1122 may indicate that the overall audit sub-report 1120 has data for a number of audited POs, discrepancies, opportunities, and a total score (i.e., an audit score for the audited POs).

Each row of the overall audit sub-report 1120 may indicate audit sub-report, including an audit score, for a site. For example, FIG. 11 shows an overall audit result row 1124. Overall audit result row 1124 indicates that at the site of “Springfield” there were five (5) discrepancies and four-hundred twenty-one (421) opportunities. Subtracting five discrepancies from four-hundred twenty-one opportunities indicates a compliant-answer score of four-hundred sixteen (416). Dividing the compliant-answer score of four-hundred sixteen by the opportunity score (number of opportunities) of four-hundred twenty-one equals an audit score of 0.988, or expressed as a percentage, 98.8%.

The audit score may be calculated on a per-buyer basis or on other groupings of auditable items, such as all auditable items from a particular site/location and within dollar range limits. FIG. 11 shows audit report 1100 with by-site-and-buyer audit sub-report 1150 and by-site-and-dollar-value audit sub-report 1160.

By-site-and-buyer audit sub-report 1150 may add buyer information to the information provided by overall audit sub-report 1120. As shown in FIG. 11, both overall audit sub-report 1120 and by-site-and-buyer audit sub-report 1150 have columns of data for a number of audited auditable items, the number of discrepancies among the audited auditable items, the number of opportunities for the audited auditable items, and a total score.

FIG. 11 shows by-site-and-buyer audit sub-report 1150 has a buyer column of data 1152. The buyer column of data 1152 may indicate which buyer or agent is servicing a particular PO and may indicate a particular buyer or agent in an audit sub-report. Each row of the by-site-and-buyer audit sub-report 1150 may indicate an audit sub-report, including an audit score, for a particular buyer at a site or location. For example, by-site-and-buyer audit sub-report row 1154 shows that buyer “98876” at site “Springfield” had two audited auditable items with 2 discrepancies and 52 opportunities leading to an audit score of 96.2%.

Similarly, by-site-and-dollar-value audit sub-report 1160 may add dollar-value information to the information provided by overall audit sub-report 1120. As shown in FIG. 11, both overall audit sub-report 1120 and by-site-and-dollar-value audit sub-report 1160 have columns of data for a number of audited auditable items, the number of discrepancies among the audited auditable items, the number of opportunities for the audited auditable items, and a total score.

FIG. 11 shows by-site-and-dollar-value audit sub-report 1160 has a PO-value-class column of data 1162. The PO-value-class column of data 1162 may indicate which class of dollar-values (e.g. less than $25,000, $25,000 to $100,000, $100,000 to $500,000, or over $500,000) a particular PO (or generally, auditable item) is worth. Each row of the by-site-and-dollar-value audit sub-report 1160 may indicate audit sub-report, including an audit score, for all POs whose worth is within a class of dollar-values at a site. For example, by-site-and-dollar-value audit sub-report row 1164 shows that POs with a class of values of “From $100” at site “Montpelier” had one audited auditable item with three discrepancies and fifty-six opportunities leading to an audit score of 94.6%.

Reports may be used in a first pass technique and/or shown to an ultimate audit customer during an audit. I-PASS 300 allows audit reports to be used in a first pass technique as I-PASS 300 generates audit reports upon request with a wide variety of selection criteria and may readily use timely data on the auditable items. Further, the audit reports generated by I-PASS 300 may be shown to the ultimate audit customer to indicate compliance with a set of regulations. I-PASS 300 may save both time and money in performing audits, ensure greater compliance with a set of regulations (such as the FAR), provide greater transparency to the ultimate audit customer by providing audit questions with definite answers, and reduce the number of actual audits required.

The audit report 1100 may provide an average score per site. The average score per site may provide average score results on a periodic basis, such as on a monthly basis. If reported on a periodic basis, the average score per site may report results for each period in the timespan between the beginning audit-report-date 1112 and the ending audit-report-date 1114. FIG. 11 shows the average score per site 1130 reporting results in November 2007 and December 2007, which are the two months (periods) between the beginning audit-report-date 1112 of Nov. 1, 2007 and the ending audit-report-date 1114 of Dec. 4, 2007.

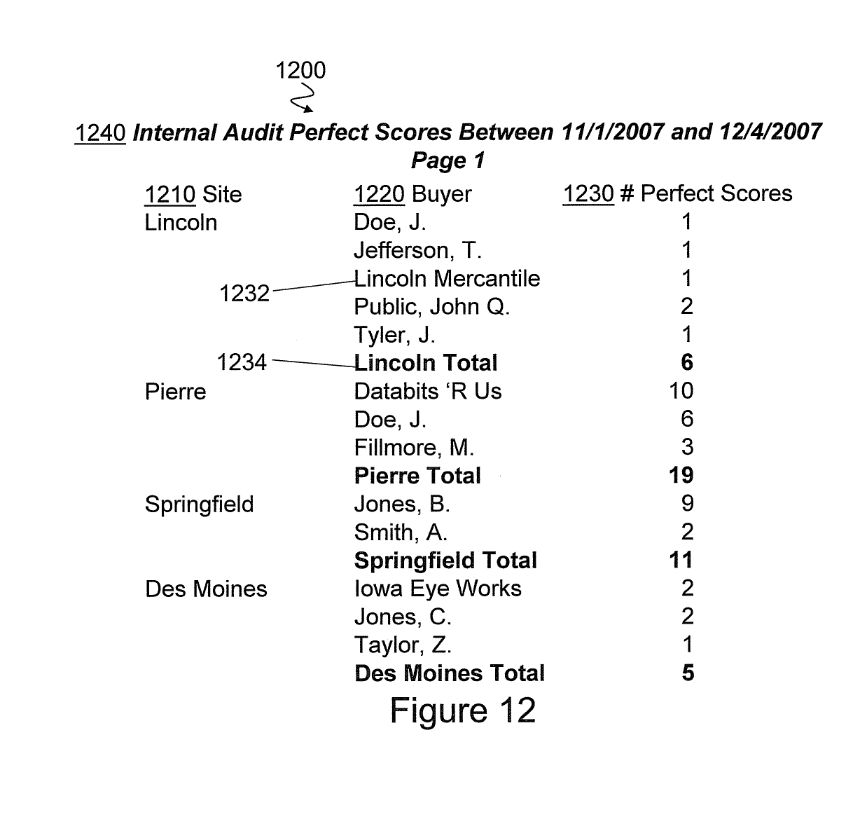

FIG. 12 shows an example of a textual audit report 1200, in accordance with an embodiment of the invention. The textual audit report 1200 has three columns of data: a site column 1210, a buyer column 1220, and a number of perfect scores column 1230. The site column 1210 and buyer column 1220 identify a site (location) and buyer for one or more auditable items, such as POs, respectively. The number of perfect scores column 1230 may indicate a number of auditable items, each of which have no discrepancies for any audit checklist associated with the auditable item. A row of the textual audit report may indicate results for a particular buyer and/or at a particular site. For example, FIG. 12 shows an example textual audit report row 1232 indicating that a buyer “Lincoln Mercantile” at a site “Lincoln” received one perfect score. A row in a textual audit report may indicate total values. For example, FIG. 12 shows an example total textual audit report row 1234 indicating a total of six perfect scores at the Lincoln site.

The textual audit report 1200 may have a title 1240. The title may provide aid a reader of textual audit report 1200 by providing background information, a timespan, and/or page numbering information. For example, the title 1240 of the textual audit report 1200 indicates background information of “Internal Audit Perfect Scores”, a timespan of Nov. 1, 2007 to Dec. 4, 2007, and a page number (one) for page numbering information. It is to be understood that a title may or may not be present in a textual audit report, that a title may report more or less information than described herein, and that the information in a title may be present in other portions of a textual audit report, such as on a title page, footer, and/or in a table of contents. Data in the textual audit report 1200 may be alphanumeric data; also, graphical qualities may be added to the alphanumeric data to provide additional data.

7. Exemplary Auditing Method

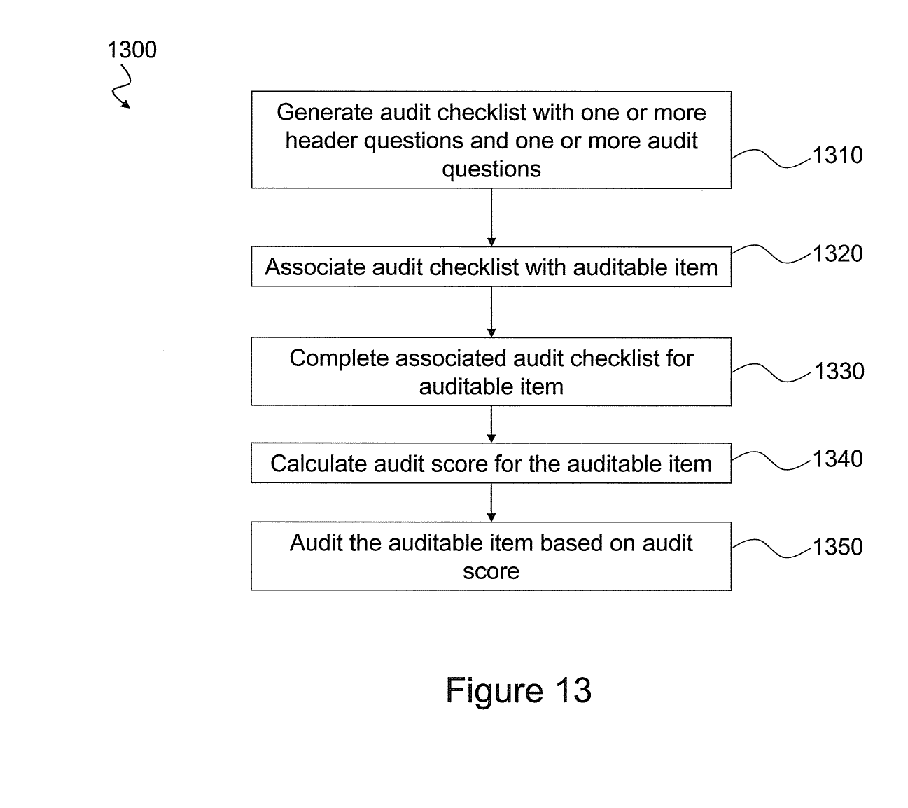

FIG. 13 is a flowchart depicting an example of a method 1300 for auditing an auditable item, in accordance with an embodiment of the invention. Preferably, the method 1300 is performed using a computing device. It should be understood that each block in this flowchart and within other flowcharts presented herein may represent a module, segment, or portion of computer program code, which includes one or more executable instructions for implementing specific logical functions or steps in the process. Alternate implementations are included within the scope of the example embodiments in which functions may be executed out of order from that shown or discussed, including substantially concurrently or in reverse order, depending on the functionality involved, as would be understood by those reasonably skilled in the art of the described embodiments.

At block 1310 of the method 1300, an auditor or other person generates an audit checklist. The auditor may use computer software and/or computer hardware to generate the audit checklist. The audit checklist may be generated by writing and/or otherwise determining one or more audit-header questions and one or more audit-checklist questions for a class of auditable items, such as purchase orders. The audit-header questions and/or audit-checklist questions may be written based on one or more sets of regulations. The audit checklist may have comments, which may be associated with the audit-checklist questions and/or the audit-header questions.

At block 1320, the auditor or other person associates an audit checklist with an auditable item. The auditable item may be associated with the audit checklist based on one or more answers to one or more audit-header questions. The audit-header questions of the associated audit checklist may be displayed on a display of a computing device. The computing device may accept answers to the audit-header questions from an input device.

At block 1330, the associated audit checklist for the auditable item is completed. The associated audit checklist may be completed by the auditor or other person by answering all of the audit-header questions and all of the audit checklist questions of the associated checklist. The computing device may display the audit-checklist questions of the associated audit checklist on a display. Then, the computing device may accept answers to the audit-checklist questions from an input device.

Each of the audit-checklist questions of the generated at least one audit checklist may be written such that each audit-checklist question has a limited number of answers. The audit-checklist questions may follow the Y/N/N/A convention. Audit-checklist questions that follow the Y/N/N/A convention may have no more than three possible answers. The three possible answers may be “Yes”, “No”, and “Not Applicable”.

The audit checklist may be structured so that the audit-header questions are earlier in the audit checklist than the audit-checklist questions. Further, the audit checklist may be structured so that answers to one or more audit-header questions determine an answer to one or more later audit-checklist questions. Also, the audit checklist may be structured so that answers to one or more earlier audit-checklist questions determine an answer to one or more later audit-checklist questions. The computing device may automatically answer later audit-checklist questions based on answers to earlier audit-header questions and/or earlier audit-checklist questions. The computing device may indicate to a user that the later audit-checklist questions have been answered. Audit comments may be accepted for each of the one or more audit-header and/or one or more audit-checklist questions.

At block 1340, an audit score for the auditable item is calculated based on the completed audit checklist. The audit score may a uniformly-weighted audit score or a non-uniformly-weighted audit score. The audit score may be determined as the questions are being answered; that is, determining the audit score may occur simultaneously or nearly simultaneously with answering audit-checklist questions, and thereby completing the audit checklist. The audit score may be calculated interactively by the computing device as questions are answered and/or as requested by user input such as a key stroke or mouse click. The audit score may be calculated based on the answers to the audit-checklist questions. The audit score of an audit checklist may be determined, in part, as a percentage or ratio of a compliant-answer score to an opportunity score.

At block 1350, the auditable item is audited based on the audit score. The audit score may be indicate the audit quality of the auditable item. An audit report may be used to audit the auditable item. The audit report may comprise the audit score and also data and/or sub-reports based on the audit score, such as tabular sub-reports of audit scores, a color-coded portion of an audit report based on the audit score, and/or other sub-reports that indicate or otherwise use the audit score. The audit score may be used in combination with one or more score ranges in determining a corrective action, such as a corrective action of requiring increased training if the audit score for the auditable item is within a particular score range.

After completing block 1350, method 1300 ends.

8. Exemplary Audit Report Generation Method

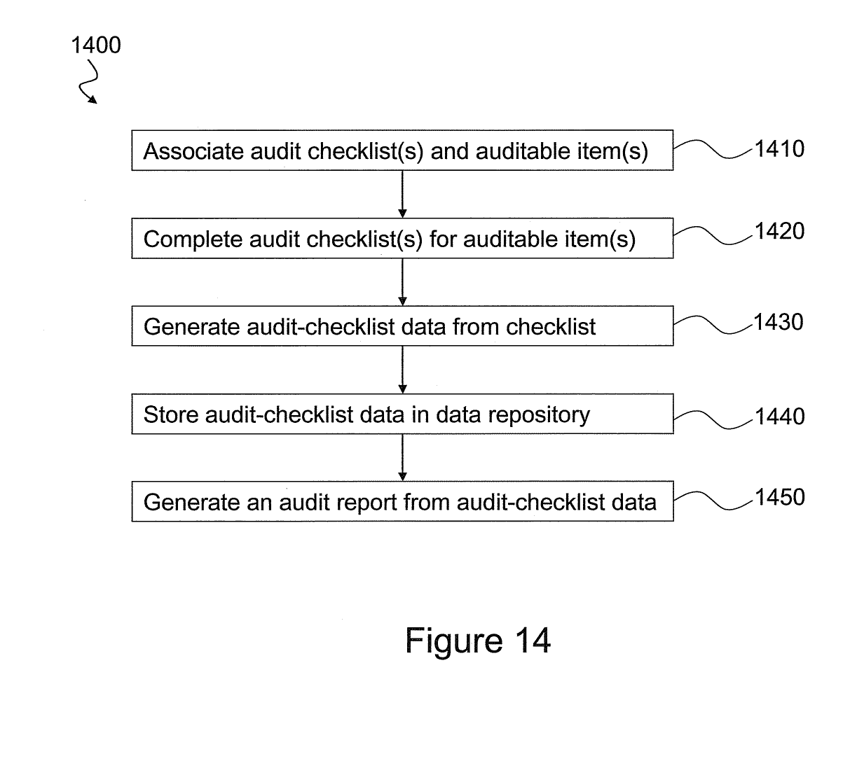

FIG. 14 is a flowchart depicting an example of a method 1400 for generating an audit report, in accordance with an embodiment of the invention. Preferably, the method 1400 is performed using a computing device. The generated audit report may be used in a first pass technique and/or shown to an ultimate audit customer.

At block 1410 of method 1400, one or more audit checklists are associated with one or more auditable items. Each of the audit checklists may comprise one or more audit-checklist questions. The audit-checklist questions may be based on a set of regulations.

The audit-checklist questions may comprise an audit-header-question portion and a audit-checklist-question portion. The audit checklists may be associated with one or more auditable items by answers to one or more questions in the audit-header-question portion. A computing device may display the questions in the audit-header-question portion and/or the audit-checklist-question portion. The computing device may accept answers to the questions in the audit-header-question portion and/or the audit-checklist-question portion. The questions in the audit-header-question portion may be displayed and/or the answers to the questions in the audit-header-question portion may be accepted via a web browser. Similarly, the questions in the audit-checklist-question portion may be displayed and/or the answers to the questions in the audit-checklist-question portion may be accepted via a web browser.

An audit-checklist question may be written an audit-checklist question has a limited number of answers. The audit-checklist question may follow the Y/N/N/A convention and therefore have no more than three possible answers. The three possible answers may be “Yes,” “No”, and “Not Applicable”. Specifically, the answer to an earlier audit-checklist question may determine that an answer to a later audit-checklist question is “Not Applicable.”

An audit checklist may be structured so that an earlier audit-checklist question may determine the answers to one or more later audit-checklist questions. Audit comments may be accepted for each of the one or more audit-header and/or one or more audit-checklist questions.

At block 1420, the audit checklist is completed. Completing the audit checklist comprises answering all questions of the audit-header-question portion and all questions of the audit-checklist-question portion.

At block 1430, audit-checklist data is generated from the completed audit checklists. The audit-checklist data may be based at least in part on the answers to the one or more audit-checklist questions of the completed audit checklists. The audit-checklist data may be raw data, calculated data (e.g. an audit score), or a combination of raw and calculated data. Raw data may be generated by storing the answers of the question(s) from the completed audit checklist(s) completed in block 1420. The audit-checklist data may include one or more audit comments.

At block 1440, the audit-checklist data is stored. The audit-checklist data may be stored in a data repository, such as data repository 340. The data repository may comprise a relational database, such as relational database 600. The relational database may store the generated audit-checklist data in one or more tables, such as header answers table 610, checklist answers table 640, and/or comments table 650.

At block 1450, an audit report is generated based at least in part on the stored audit-checklist data. A computing device may display, print, transmit, fax, store, and/or otherwise process the generated audit report. User input, such as timespan, award-type, and/or other selection criteria, may be used in generating the audit report.

An audit report generator 350 may generated the audit report based on the stored audit-checklist data. The audit report generator 350 may be configured to retrieve stored audit-checklist from the data repository. The audit report generator 350 may use one or more database queries to retrieve the stored audit-checklist data. The audit report generator 350 may include some or all of the user input, such as timespan information or an audit-type, in the database queries. The generated audit report may be a textual audit report and/or a graphical audit report. Note that a mixed textual and graphical audit report is possible as well.

An audit report may report information using various selection criteria. The possible selection criteria for an audit report may depend on the stored audit-checklist data. For example, if audit-checklist data is stored using the tables indicated in FIG. 9, selection criteria of any one value or any combination of values in the header answers table 610 may be used as selection criteria.

Selection criteria may depend on data determined from stored-checklist data. For example, the number of discrepancies for an auditable item may be determined from stored checklist answers, such as checklist answers table 640. Then, a selection criteria of a perfect score may be determined by selecting all auditable items whose number of discrepancies has been determined to be zero (i.e., a perfect score has no discrepancies).

After completing block 1450, method 1400 ends.

9. Conclusion

While certain features and embodiments of the present invention have been described in detail herein, it is to be understood that the invention encompasses all modifications and enhancements within the scope and spirit of the following claims. It should be understood, however, that this and other arrangements described in detail herein are provided for purposes of example only and that the invention encompasses all modifications and enhancements within the scope and spirit of the following claims. As such, those skilled in the art will appreciate that other arrangements and other elements (e.g. machines, interfaces, functions, orders, and groupings of functions, etc.) can be used instead, and some elements may be omitted altogether.

Further, many of the elements described herein are functional entities that may be implemented as discrete or distributed components or in conjunction with other components, in any suitable combination and location, and as any suitable combination of hardware, firmware, and/or software.

What is claimed is:

1. A system, comprising:
a processor;
a display;
an input device; and
data storage containing machine language instructions and comprising instructions executable by the processor to:
on the display, display an audit-header question of an audit checklist;
from the input device, receive an audit-header answer to the audit-header question;
associate at least one auditable item with the audit checklist, based on the audit-header answer;
on the display, display an audit-checklist question of the audit checklist;
from the input device, receive an audit-checklist answer to the audit-checklist question; and
complete the audit checklist for the associated at least one auditable item, based on the audit-checklist answer.

2. The system of claim 1, wherein the machine language instructions further comprise instructions executable by the processor to:
generate at least one audit report, based on the completed audit checklist.

3. The system of claim 2, wherein the machine language instructions comprise instructions executable by the processor to generate the at least one audit report based on input from a user.

4. The system of claim 2, wherein the machine language instructions to generate at least one audit report are executable by the processor to:
generate audit-checklist data from the completed audit checklist,
store the audit-checklist data, and
generate the at least one audit report based on the stored audit-checklist data.

5. The system of claim 4, further comprising:
a communication interface communicatively coupling the processor and a data repository,
wherein the communication interface is operable to send the audit-checklist data to the data repository, and
wherein the data repository is configured to store the audit-checklist data.

6. The system of claim 5, further comprising an audit report generator, wherein the audit report generator is operable to generate the at least one audit report based on the stored audit-checklist data.

7. The system of claim 4, wherein the machine language instructions comprise instructions executable by the processor to store the generated audit-checklist data in a relational database.

8. The system of claim 1, wherein the instructions executable by the processor to accept an audit-checklist answer to the audit-checklist question from the input device comprise instructions executable to:
accept at most three possible answers to the audit-checklist question, and
accept an audit comment for the audit-checklist question.

9. The system of claim 8, wherein the three possible answers are “Yes”, “No”, and “Not Applicable” and wherein the instructions are further executable to determine an answer is “Not Applicable” for a first audit-checklist question based on the accepted answer to a second audit-checklist question.

10. The system of claim 1, wherein the machine language instructions comprise instructions executable by the processor to accept user input from a web browser to answer the audit-checklist question.

11. A method for auditing an auditable item, comprising:
generating an audit checklist, wherein the audit checklist comprises an audit-header question and an audit-checklist question;
associating one or more auditable items with the audit checklist;
completing the audit checklist for each of the one or more auditable items;
calculating an audit score for each of the one or more auditable items, based on the completed audit checklist for the auditable item; and
auditing the one or more auditable items, based on the audit score for each of the one or more auditable items.

12. The method of claim 11, wherein each of the one or more audit-checklist questions has no more than three possible answers and wherein the no more than three possible answers are “Yes”, “No”, and “Not Applicable”.

13. The method of claim 11, further comprising:
answering an audit-header question; and
associating the answered audit-header question with at least one audit-checklist question, whereby based on the answered audit-header question, the associated at least one audit-checklist question has only one possible answer.

14. The method of claim 13, wherein the only one possible answer is “Not Applicable”.

15. The method of claim 11, wherein calculating the audit score for each of the one or more auditable items further comprises calculating the audit score simultaneously with completing the audit checklist.

16. A computerized method for generating at least one audit report, comprising:
associating an audit checklist with one or more auditable items;
generating audit-checklist data from the associated audit checklist;
storing the generated audit-checklist data in a data repository; and
generating the at least one audit report based on the stored audit-checklist data.

17. The method of claim 16, wherein the at least one audit checklist is based on at least one set of regulations.

18. The method of claim 16, wherein generating audit-checklist data comprises:
for each of the one or more auditable items, completing the associated audit checklist; and
for each of the one or more auditable items, generating audit-checklist data based on the completed audit checklist.

19. The method of claim 16, wherein at least one auditor completes the at least one audit checklist.

20. The method of claim 16, wherein the data repository comprises a relational database.
